(19) United States
(12) Patent Application Publication
(10) Pub. No.: US 2022/0089949 A1
(43) Pub. Date: Mar. 24, 2022

(54) METHOD FOR PRODUCTION OF QUANTUM RODS USING FLOW REACTOR

(71) Applicant: Zhuhai Roumei Technology Co.,Ltd., Zhuhai City (CN)

(72) Inventors: Maksym F. Prodanov, Hong Kong (CN); Valerii Vladimirovich Vashchenko, Hong Kong (CN); Abhishek Kumar Srivastava, Hong Kong (CN)

(21) Appl. No.: 17/480,731

(22) Filed: Sep. 21, 2021

Related U.S. Application Data
(60) Provisional application No. 63/081,866, filed on Sep. 22, 2020.

(30) Foreign Application Priority Data
Sep. 22, 2020 (CN) 202011004288.1
Mar. 19, 2021 (CN) 202110296976.8
Mar. 19, 2021 (CN) 202120575554.X

(51) Int. Cl. C09K 11/88; B01J 19/24; B01J 19/00

(52) U.S. Cl. CPC C09K 11/883; B82Y 20/00; B01J 19/0013; B01J 19/248

(57) ABSTRACT

A method for production of quantum rods is semiconductor luminescent nanoparticles of elongated shape. The semiconductor luminescent nanoparticles are core-shell nanoparticles, where core is CdSe coated with CdS shell. At the current state of the art, mass production of this type of quantum rods is challenging because of extremely fast growth of wurtzite CdSe seeds serving as the core, especially when the seeds size is below 3.0 nm that is required for synthesis of green emitting QRs. We propose the non-injection method for CdSe-seeds which comprises: preparation of single reaction mixture containing both Cd- and Se-precursors, which is liquid at room temperature: pumping the reaction mixture through the heating zone specially designed to provide highly reproducible and well-controllable residential time (0.1-60 seconds) in a heating chamber, thereby resulting in CdSe seeds with low size distribution and narrow emission bandwidth; synthesis of quantum rods using the prepared CdSe seeds.

### TECHNICAL FIELD

The present disclosure relates to the technical field of production of quantum rods, and in particular to a method for producing quantum rods using a flow reactor.

### BACKGROUND

1. United States patent US20160375495. A continuous flow reactor for the efficient synthesis of nanoparticles is described. Embodiments and claims disclosed a flow reactor where microwave energy source is used for rapid nucleation of the precursors following by a separate heating source for growing the nucleates. Segmented flow (gas bubbles separated flow of liquid) is used to facilitate mixing and uniform energy absorption of the precursors. Post-synthesis quality testing is communicated with a control system allows automatic real-time adjustment of the production parameters. The key point of invention is usage of microwave heating source for the first step of synthesis. The utility of the flow reactor for synthesis of luminescent nanoparticles (and their PL properties) is not shown.

2. United States patent US20120001356. Disclosed are embodiments of a continuous-flow injection reactor suitable for continuous synthesis of materials, e.g., nanoparticles. The continuous-flow injection reactor includes a mixing zone unit having (i) an outer housing with a top inlet, a bottom outlet, and a side inlet positioned between them and perpendicular to the both top inlet and the bottom inlet, (ii) an injection tube inserted into the top inlet and positioned concentrically within the outer housing, the injection tube being of sufficient length to extend past the side inlet while terminating above the bottom outlet, and (iii) a mixing zone between a lower end of the injection tube and the bottom outlet of the mixing zone unit. A first fluid source operably coupled to the side inlet; a second fluid source operably coupled to the injection tube inserted into the top inlet; and a residence time unit, wherein the residence time unit has a diameter cooperatively dimensioned such that it can be removably coupled to the bottom outlet of the mixing zone unit. The invention fully based on idea of mixing of the precursors solutions in flow. Thus, the mixing zone is necessary for the proposed reactor and any option to use a single (combined) precursors mixture is not foreseen. Utility of the method for synthesis of luminescent nanoparticles (and their PL properties) is not shown and any detailed design of heating zone is not provided.

3. United States patent US20110104043. A continuous flow system for the synthesis of nanoparticles is disclosed. The system includes a feeding unit connected to the flow path of the reactor units, where at least one first reactor unit possesses a heating zone and at least one second reactor unit, which follows the first reactor in the same cascade. Each heating reactor-zone is equipped with temperature controller and followed by a cooling unit in the cascade. Between the two first reactor units is a mixing unit connected with a second feeding unit. The second feeding unit connected to a raw material source and/or a control unit, equipped with at least one pressure controller. The disclosed flow reactor is designed for the synthesis of nanoparticles, preferably metal-containing nanoparticles, and nanoparticles of biologically active organic molecules. Similarly to Background [0003], the mixing zone is necessary for the proposed flow reactor and any option to use the single (combined) precursors mixture is not proposed. Additionally, when the disclosed flow reactor was used for production of semiconductor nanoparticles, the low-quality of CdSe NPs of very broad emission bandwidth (FWHM≈60-90 nm) is obtained.

4. United States Patent US20140026714. A continuous flow reactor for nanoparticle synthesis comprises a modular system including a plurality of interconnected tubular components for fluid flow there through including a first tubular inlet and a second tubular inlet connected to a three-way junction comprising a tubular mixer. A continuous flow method for nanoparticle synthesis comprises (i) flowing a growth solution and a reaction-initiating solution into a mixing portion of a flow reactor to form a mixed solution (ii) flowing the mixed solution through a holding portion of the flow reactor for a predetermined residence time to form a reacted solution comprising nanoparticles and (iii) continuously removing the reacted solution from the flow reactor so as to achieve a throughput of nanoparticles of at least about 0.5 mg/min. The proposed flow reactor comprises mixing unit, thus it is not design for non-injection processes. Additionally, because no heating zone are provided in the design, Thus the proposed flow reactor is not suitable for synthesis of luminescent nanoparticles.

5. United States Patent US20110042611. The apparatus and the method for the manufacture of nanoparticles allows for the nucleation and growth of nanoparticles at independent temperatures. The independent temperatures allow for the growth of nanoparticles in a controlled environment avoiding spontaneous nucleation and allowing particle sizes to be controlled and facilitating the manufacture of particles of a substantially uniform size. The patent does not provide any special solution for the flow reactor design including the key unit—heating zone. The method implies mixing of at least two reaction precursors in the hot zone and no option to use the single (combined) precursor mixture is provided. Similarly to the above discussed Background [0002], [0003] and [0005], capabilities of the method for synthesis of high quality luminescent materials are not claimed.

6. Hongwei Yang, Weiling Luan, Shan-tung Tu, Zhiming M Wang; Crystal Growth and Design 2009, 9, 1569. The work describes synthesis of luminescent CdSe nanocrystals in flow using two independently prepared precursors solutions, pumped in a convective mixer following to heating zone, which is serpentine microchannel, dipped in a preheated and thermally stabilized oil bath. The capabilities (flow rate) of the described approach are limited, as microflow (<10 ml/h) is required for operation with microchannel of big length. Moreover, for preparation of green-emitting QDs, high dilution of the reaction mixture was required (˜10 times), significantly reducing the productivity of the method. In addition, the use of pre-heated oil bath in heating zone is not safety taking into account the high temperature needed for synthesis of highly crystalline wurzite CdSe seeds (320-380° C.) and the proposed use of PTFE capillaries is also not possible at this temperature.

7. Tobias Jochum, Daniel Ness, Marieke Dieckmann, Katja Werner, Jan Niehaus, Horst Weller; Mater. Res. Soc. Svmp. Proc. 2014, 1635, 97. The authors presented a synthetic route for the production of wurtzite CdSe nanocrystals, for further shell growing reaction (e.g. CdSe/CdS dot-in-rod nanoheterostructures). The continuous flow reactor set-up consists of a separate nucleation chamber and growth oven. The authors stated that both components can be heated up to temperatures above 350° C. to guarantee WZ crystal structure, however, the description of flow reactor design and experimental procedures are presented only in a very general manner and does not provide any specific details of the heating zone design which is a key for synthesis of highly crystalline wurzite CdSe seeds with low size distribution and good PL properties.

8. Matt S. Naughton, Vivek Kumar, Yolanda Bonita, Kishori Deshpande, Paul J. A. Kenis; Nanoscale 2015, 15895. The paper shows continuous flow reactors for the synthesis of CdSe, CdS, and CdSeS (alloy) quantum dots in single step procedures that did not require in-line mixing. Quantum yields of up to 60% were achieved by overgrowing ZnS shell or CdS shells with only one added reaction step in the case of CdSe or CdSeS. The method does not allow preparation of CdSe nanocrystals of wurtzite crystal type (which is required for synthesis of CdSe/CdS quantum rods) but rather of sphalerite crystal type taking into account the conditions of the synthesis (270° C., oleic acid as a ligand in ODE).

9. Manabu Kawa, Hidekazu Morii, Atau Ioku, Soichiro Saita, Kikuo Okuyama; Journal of Nanoparticle Research 2003, 5, 81. Organically capped CdSe nanocrystals were produced by a continuous flow reactor in 13 g/h rate as isolated CdSe nanocrystal, using trioctylphosphine oxide (TOPO) served as both the capping organic reagent and the high temperature reaction solvent. However, the paper does not provide any specific details of the heating zone, which design is a key for synthesis of highly crystalline wurzite CdSe seeds with narrow size distribution and good PL properties. No examples of the obtained CdSe QDs for synthesis of quantum rods are shown as well as CdSe crystal type is not mentioned. In addition, according to the proposed method, TOPO is used as a solvent, which is solid at r.t., thereby, additional heating of all the tubes and pumps is required.

10. Jun Pan, Ala'a O. El-Ballouli. Lisa Rollny, Oleksandr Voznyy, Victor M. Burlakov, Alain Goriely, Edward H. Sargent. Osman M. Bakr; ACS Nano 2013, 7, 10158. High-quality PbS CQDs with high photoluminescence quantum yield and narrow full width-half max. values were prepared via an automated flow-synthesis methodology. The scope of the described flow reactor is synthesis of PbS quantum dots which possess emission in IR spectral range. The nucleation and growth temperatures are relatively low (150° C.), thereby the method is not applicable for synthesis wurtzite CdSe QDs.

11. Ahmed Lutfi Abdelhady, Mohammad Afzaal, Mohammad Azad Malika, Paul O'Brien; J. Mater. Chem. 2011, 21, 18768. Syntheses of CdSe, CdS, CdSe/CdS core/shell, and CdSeS alloy nanoparticles in microcapillary tubes using SSPs have been carried out. Blue emitting, OLA capped CdSe nanoparticles were synthesized from [Cd(Se₂PiPr₂)₂]. The proposed approach based on a simple pumping the solution of the single [Cd,Se] element precursor by the syringe pump through the microcapillary, immersed into the hot oil bath. The method allows the preparation only blue emitting CdSe QDs of cubic (zinc blende) crystal structure at low productivity due to low flow rate limited to a few ml/h.

12. H. Wang, H. Nakamura, M. Uehara, Y. Yamaguchi, M. Miyazaki, H. Maeda; Adv. Funct. Maier. 2005, 15, 603. An air-stable, low toxic, single molecular source for ZnS is demonstrated to be an appropriate reagent to synthesize highly luminescent ZnS-capped CdSe with a narrow size distribution. A photoluminescence quantum yield of above 50% and a photoluminescence peak full width at half maximum of around 32 nm could be obtained after synthesis using a micro flow reactor. The work describes application of flow synthesis approach for synthesis of high quality shell material on top of pre-synthesized CdSe QDs. The method is based on a simple pumping the solution of the single [Zn,S] element precursor by the syringe pump through the microcapillary (ID˜200 μm), immersed into the hot oil bath. The drawback of this method is similar to those in Background [0012]: low productivity, using of an oil bath at high temperature.

13. Hiroyuki Nakamura, Yoshiko Yamaguchi, Masaya Miyazaki, Hideaki Maeda, Masato Uehara, Paul Mulvaney; Chem. Commun. 2002, 2844. Micro-reactor was utilized to produce CdSe nano-particles continuously by continuous injection of the raw-material solution for CdSe into a pre-heated glass capillary type micro-reactor. The method is based on a simple pumping the solution of the element precursors by the syringe pump through the microcapillary (ID˜200 μm), immersed into the hot oil bath. No PL properties of the obtained materials are shown. The use of pre-heated oil bath in heating zone is not safety taking into account the high temperature needed for synthesis of highly crystalline wurzite CdSe seeds (320-380° C.) and the proposed apparatus is limited to low productivity (small flow rate of few ml/hour) due to required use of microsized cappilaries.

14. Han E. H. Meijer, Mrityunjay K. Singh, Patrick D. Anderson, “On the performance of static mixers: A quantitative comparison”, Progress in Polymer Science 37 (2012) 1333-1349. The performance of industrially relevant static mixers and the newly proposed design series of the SMX (Static Mixer using crossbars X) is compared. The SMX mixer creates like the Kenics two co-rotating vortices, which give the extra interface, and combines that with extra interface folding. It is shown that, in compactness, the new series SMX(n), like the SMX(n=3) (3, 5, 9) design, outperform all other devices with at least a factor 2.

### SUMMARY

Aspects and advantages of the disclosure will be set forth in part in the following description, or may be obvious from the description, or may be learned through practice of the embodiments. The present disclosure provides a method for production of quantum rods using a flow reactor.

The core-shell QRs are currently obtained by two-steps procedure, where first step is synthesis of the CdSe core and second one is growing the rod-shaped CdS shell coated the core. The general scheme of QRs synthesis is represented in FIG. 1. The first step, synthesis of the CdSe core, is typically represented by injection method, wherein a [Se] precursor is swiftly injected into preheated a [Cd] precursor at a high temperature (270-300° C. in the case of zinc-blend crystal structure of NP and 320-370° C. in the case of wirtzite crystal type).

The flow reactor (FR) technique is a powerful tool for large scale chemical synthesis and also provides several advantageous compared to traditional “batch” synthesis, wherein key one is more precise control of fast chemical reaction since the process is very sensitive to the time of heating/cooling. Another potential advantage of flow-process is ability for very fast heating of the reactants in flow at the proper design of the hot-zone, where the heating rate is comparable to those at a hot injection technique, thereby enabling a non-injection process, which is technically more simple. Thus, regarding to synthesis of QRs, implementing of high rate (flash) heating and subsequent cooling, the flow synthesis can provide the required low size distribution and PL quality of the obtained wurtzite CdSe seeds, suitable for the following preparation of CdSe/CdS QRs.

Currently only few examples of synthesis of CdSe QDs in flow, providing acceptable size distribution and optical quality, were reported [Background 6 and 7]. However, all these processes are only in a microflow regime (Background [0007]) and the reports do not contain any description of the key experimental details such as design of the heating chamber, type of the pumps used, material used in hot zone etc. (Background [0008]). Thus, the solution for the flow synthesis of w-CdSe QDs with high productivity and tunable size is still required for the following preparation of green- and red-emitting CdSe/CdS QRs.

The general configuration of flow system should include pump, hot zone, cooler, online detector and product collector. The purpose and basic requirements for the main units of the flow system are as follows:
1) Pump
   a. Should provide stable and preferably pulse-less flow rate in wide enough range of backpressure.
   b. Should has enough chemical resistance of wet parts against the precursors used;
2) The chamber in hot-zone must provide:
   a. Well mixing of the reaction mixture as well as fast and reliable heat transfer to the reaction mixture. Therefore, within the heat channel, the ratio of internal walls area to internal volume of heated zone (S/V) should be high enough and accompanied with efficient heat supply to the reaction zone. Additionally, the mass of the heater working part should exceed the mass of flowing reaction liquid by several times.
   b. Spatially uniform time of occurrence of the reaction mixture in hot zone (residential time). Thus, the chamber must operate in “plunger mode” avoiding any flow stagnation places. For this, special design of the chamber is needed which will increase the resistance to flow and, thereby, can rise the backpressure.
   c. Dividing the Hot zone into several independently controllable section for optimization of the temperatures for preheating, nucleation and growth of nanoparticles. Heating unit should provide fast “flash” heating of reaction mixture. The volume of each hot zone determines the residential time (time the reactants spend in the hot zone) in each zone and the ratio of residential time for nucleation and growth should be in the range from 1:10 to 1:1.
3) Cooler should provide sharp “flash” cooling the reaction mixture (to terminate growth of CdSe QDs) to the temperatures well below 180° C.
4) Fluorescent detector (optionally) is needed for in-situ monitoring of the process and fast feedback to adjust the flow rate or/and temperature in the hot zone.

All known method for synthesis specifically the w-CdSe QDs, which are further used in production of high quality CdSe/CdS QRs, are based on hot injection of Se-precursor to Cd-precursor. As a Cd-precursor, the Cd salts of alkylphosphonic acids are used, where the nature of acids is a key prerequisite for the formation of non-symmetrical w-CdSe QDs, suitable for further use as seeds for QRs. As a Se-precursor, the Se solution in trioctylphosphine (TOP) is used which is a TOPSe/TOP mixture. The reaction is carried out in trioctylphosphine oxide (TOPO). The temperature of hot injection is typically in the range of 340-380° C. and the appropriate reaction time is varied from a few to tens of seconds depending on the required CdSe QDs size. This chemical process is well studied and optimized for hot injection synthesis in batch-reactor, however, it cannot be directly adopted for flow reactor synthesis because of several reasons.

The main obstacle in adopting of the QDs flow reactor synthesis concerns the aggregated state and solubility of precursors. Among the two precursors, [Se] and [Cd], only Se-precursor is a homogeneous liquid at room temperature. Concerning the Cd-precursor, the used solvent, TOPO, itself is a solid at room temperature (m.p.=54° C.) and the used=15 wt. % of solid Cd-alkylphosphonate in this solvent additionally solidify the composition. Thus, it is needed to install an additional hot jacket (to maintain temperature well above the m.p. of the materials, ˜75-80° C.) in all lines from [Cd] reservoir all the way through the pump and up to high-temperature zone.

Alternatively, the Cd salts can be used as suspension in the mixture of solvents; however, it seriously limits the choice of applicable pumps and variation of the flow rate. In such a case, high-pressure (up to 300 bar) and providing highly accurate flow (less than 0.1% of deviation) piston pumps (e.g. HPLC preparative pumps) are inapplicable because of valves, which are extremely sensitive to the presence of any solid materials in the pumped liquid. The alternative pumps, with inert wet parts, are of peristaltic or valve-less piston types, which are capable to operate within the Cooler However, in general, they work with essential pulsing the pressure (and, thereby, flow rate) and are limited in backpressures of 6-7 bars only. In addition, the solidifying of reaction mixture upon cooling can bring serious problem in cooler unit (see Error! Reference source not found.), due to possible partial or even full blocking, which further results in deterioration the quality of the QRs seeds and even to accident. Additionally, on-line fluorescence detection also requires flow of homogeneous liquid rather than suspension.

Second, adopting the hot-injection protocol, the flow system must include two pumps for each precursor, which additionally increases the cost and complexity of the whole apparatus. This also limits the application of two peristaltic pumps working at different flow rate because of possible back flow to the slower pump. Moreover, special design of mixer is required, which should provide fast and effective mixing in a confined volume.

We have examined the behavior of reaction mixture comprising both Cd- and Se-precursor in TOPO at temperature slightly above its solidification temperature (˜60° C.). Monitoring of PL and absorption spectra has revealed that no reaction occurs in inert atmosphere during at least a week after mixing. Then, using the aliquot of thus aged solution, the CdSe synthesis in flow was modelled by fast “flash” heating of reaction mixture by means of its fast dipping in a thin-wall stainless steel reaction vessel to pre-heated (420° C.) molten tin bath. PL measurements shown that within seconds after the dipping, regular CdSe QDs formed (Error! Reference source not found.). These seeds, after isolation and treatment with S- and Cd-precursors, result in formation of CdSe/CdS QRs of acceptable quality (Error! Reference source not found.). Further studying of temperature effect on the combined [Cd] and [Se] reaction mixture, revealed that it is stable up to 120° C. without any reaction/degradation. Above this temperature, reaction of [Cd] with [Se] begins resulting in CdSe nucleation.

These experiments clearly show, that in the properly designed flow chamber, the mixing step in flow reactor of separated [Cd] and [Se] precursors can be omitted. Instead, both precursors can be pre-mixed, prior reaction in hot zone, which significantly simplifies whole flow reactor design and operation.

To make the reaction mixture liquid at r.t. we propose to change the solvent TOPO with TRPO which is statistic mixture of R₃P(O), R₂R′P(O), RR′₂P(O) and R′₃P(O) (where R=hexyl and R′=octyl) and is liquid at r.t. with melting point around 5° C. Chemically, TRPO is of the same nature as TOPO, and therefore, the same reactivity of QDs/QRs precursors should be expected in this solvent. We have confirmed this assumption experimentally in the batch reactor by synthesis of both CdSe QDs and CdSe/CdS QRs, and as expected, the NPs of the same quality as in TOPO were produced. Additional advantage of TRPO is its high dissolution ability towards some Cd salts. Even at room temperature, TRPO can dissolve Cd-hexadecylphosphonate in =15% wt. concentration, which is high enough for application in QDs/QRs synthesis protocol. Thus, use of TRPO allows to avoid the application of any additional heating jacket over all units of the flow system. Moreover, with TRPO the cold water or even a chilling agent can be used in the cooler, instead of thermally stabilized cooling media above the melting point of the reaction mixture (see Error! Reference source not found.). The last is also preferred for flash cooling of the reaction mixture.

Additionally, the homogeneous solution of precursors in the TRPO allows us to deploy reliable piston-type pumps (e.g. HPLC pumps) instead of peristaltic or valve-less piston pumps, as a solution delivery unit in flow reactor (Error! Reference source not found.). The advantages of the piston-type (HPLC-type) pumps are:
Pulse-less high flow rate (up to liters per min) at high backpressure (200-300 bar and more).
Pulse-less flow is favourable for high uniformity of the residential time in hot-zone, which is the prerequisite of high quality and low size distribution of any type of nanoparticles
High flow rate is required for a high throughput of the flow-system
The high backpressure operations enables us to change the chamber design that can be optimized for the suitable heat transfer and mass-mixing during the reagents passing through the hot-zone. Additionally, it allows using a lower diameter of connecting tubes in between flow-system units, which minimizes “dead volume” and reduces distortion of the flow front.

Thus, keeping the general idea of the flow system, we seriously expand its scope. The proposed flow system configuration is given in Error! Reference source not found.3.

The goal is achieved by independent precise control of reaction time and temperature including “flash” heat-up and cool-down of the reaction mixture entering and leaving out the heating zone correspondingly, resulting in a boosted nucleation and homogeneous growth of the nanoparticles. The proposed method furnishes the high-quality CdSe seeds further used to prepare quantum rods with a very well reproducible PL properties including high photoluminescence quantum yield and narrow emission bandwidth in 500-650 nm spectral range.

These and other features, aspects and advantages of the present disclosure will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure to one of ordinary skill in the art is set forth more particularly in the remainder of the specification, including reference to the accompanying figures, in which:

FIG. 1. General scheme for synthesis of CdSe/CdS core-shell quantum rods;

FIG. 2. PL and absorption spectra of CdSe QDs obtained by flash heating of reaction mixture in pre-heated liquid tin bath and PL spectra of CdSe/CdS QRs obtained from these seeds;

FIG. 3. Working design of the flow system. Green lines denoted the PTFE tubing (ID=1 mm), dark-blue lines are stainless steel tubing (ID=0.5 mm). All units, tubing and connections from pump outlet until inlet of the valve 2 are designed to work under elevated pressure, up to at least 275 bar;

FIG. 4. Schematic drawing of column type chamber with tiller,

FIG. 5. Schematic drawing of assembly of flow reactor comprising 3 empty-channel units in 3 hot zones. Details of the said unit is given at FIG. 6;

FIG. 6. Drawing of assembly of flow reactor unit in hot zone comprises metal block with continuous empty microchannel inside. Details of the said continuous empty microchannel patterning are given at Error! Reference source not found. and Error! Reference source not found.;

FIG. 7. Drawing of the substrate of metal block of flow reactor, wherein a continuous empty microchannel on the surface of the said substrate has a zigzag periodical patterning. Typical sizes of the microchannel are 500 μm width and 100 or 200 μm depth;

FIG. 8. Drawing of the substrate of metal block of flow reactor, wherein a continuous empty microchannel on the surface of the said substrate is a periodical plurality of divergent and convergent micro channels. Typical sizes of the microchannel are 500 sm width and 100 or 200 μm depth;

FIG. 9. Schematic drawing of coil type chamber of flow-reactor;

FIG. 10. (a) PL spectra of CdSe QDs seeds obtained in coil type chamber flow reactor, ID=1 mm (see FIG. 9) at different flow rate (residential time). Temperature was set to 430° C. for both hot zones;

FIG. 11. PL spectra of CdSe QDs obtained in column type of flow reactor (see FIG. 4) at different flow rate: (a) Sizes of tubing ID=2.0 mm, L=150 mm, Temperature was set to 365, 350, 350° C. in three consecutive heating zones; (b) Sizes of tubing ID=4.6 mm, L=75 mm, Temperature was set to 400, 320 and 320° C. in three consecutive heating zones; and

FIG. 12. (a) PL spectra of CdSe/CdS QRs prepared from CdSe seeds synthesized in column type of flow reactor (see FIG. 4), FWHM=31 and 38 nm for green and red emitting QRs correspondingly; TEM photo of (b) green and (c) red QRs.

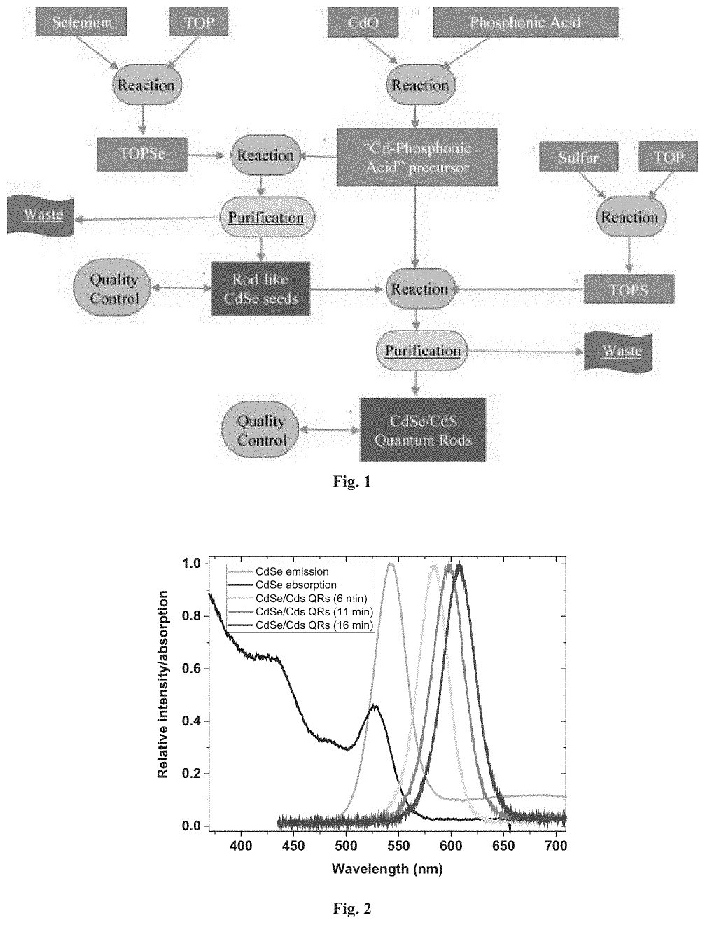

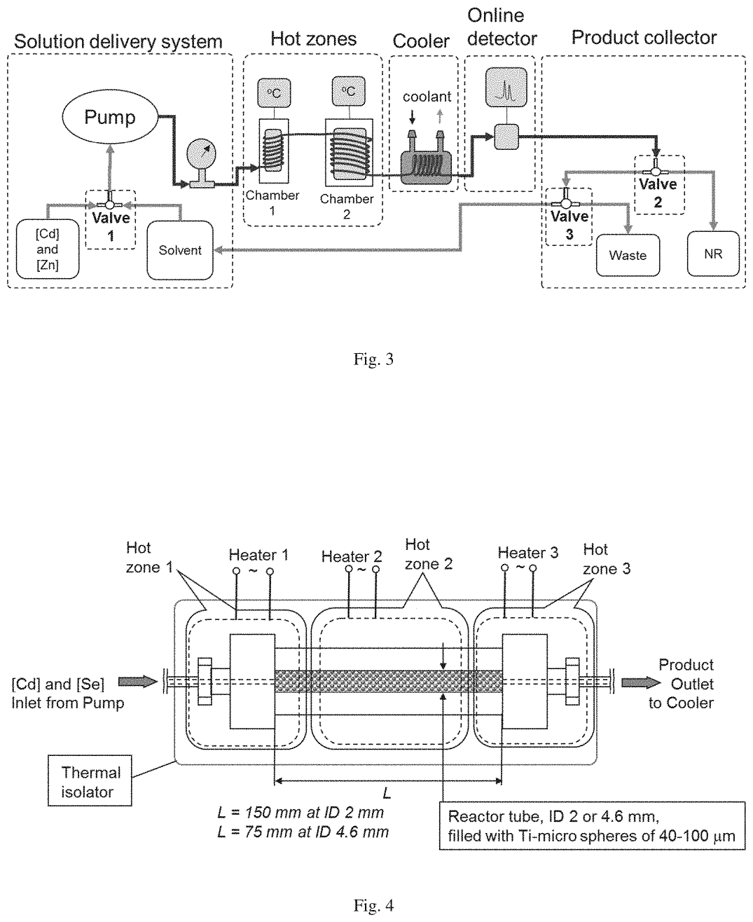

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

General Introduction

CdSe/CdS core-shell quantum rods (QRs) are semiconductor nanoparticles of elongated shape with additional advantages over quantum dots (QDs), namely: linearly polarized emission, lower PL quenching in the film and higher thermal stability. Particularly, parallel aligned QRs in films are used as enhancement films (EF) for display backlight applications in liquid crystalline displays (LCDs) and are competitive alternative materials to replace quantum dot enhancement films (QDEFs) which are used in current state of the art. Due to polarized emission, the QRs, which are mainly concerned to core-shell CdSe/CdS nanorods, can increase the colour gamut of LCDs and improve considerably their overall optical efficiency. These advantageous of QRs are also in high demand for application in LEDs either as on-chip light convertors or as utilizing electroluminescent effect.

For display applications QRs with λₑₘ=620-630 nm and λₑₘ=520-525 nm and are required for red and green colours. In order to provide colour purity and expand colour triangle, the width of emission band of the QRs (FWHM) should not exceeded 35 nm, preferably 25-30 nm.

The core-shell QRs are currently obtained by two-steps procedure, where first step is synthesis of the CdSe seeds, further used as a core, and second step is growing the rod-shaped CdS shell coating the CdSe core.

The first step is the most challenging because of extremely fast growth of wurtzite CdSe (w-CdSe) seeds, especially when the particle size is below 3.0 nm that is required for synthesis of high-quality of green emitting QRs. An essential red shift during the following CdS shell growth additionally aggravates the problem compelling to reduce the size of the seeds to as small as 2 nm. where the required reaction time is shortened to few seconds. Such synthetic requirements are well-beyond of capability of the batch reactor synthesis using both hot-injection or non-injection methods, where it is almost impossible to cool down the reaction mixture from 370° C. to below 200° C. in few seconds, especially in the case of large-scale synthesis.

Methods based on dilution of reaction solutions or use of less reactive element precursors cannot result in formation of rod-like nanoparticles as both concentration and reactivity are key prerequisites for shape control during anisotropic growth. Any options to achieve better control on the reaction time of w-CdSe seeds synthesis by decreasing the temperature of reaction, are not applicable to high-quality w-CdSe of small size, since a lower temperature always favours to formation of smaller number of initial CdSe nuclei, whereas the further growing rate of CdSe over the nuclei weakly depends on temperature. Thus, instead of smaller-sized CdSe, the nanoparticles of larger size forms. Additionally, at lower temperature the CdSe nanoparticles of worse crystallinity are obtained, which deteriorates the luminescent properties of the following CdSe/CdS rods. Moreover, at lower temperature CdSe nanocrystals with cubic lattice type (zinc blende) forms as this crystal type is kinetically more preferable. Special techniques of fast reaction cooling, for example either by dipping of reaction vessel to cold acetone and/or 2-propanole bath or by injection of a cold solvent into reaction mixture, also do not allow to control the cooling rate reproducibly even in low-scale synthesis (of few tens of mL of reaction mixture) and is not applicable when scaling up the synthesis.

Here, we propose the non-injection method which comprises: a) preparation of single reaction mixture containing both Cd- and Se-precrursors, which is liquid at room temperature; b) pumping the reaction mixture through the heating zone specially designed to provide extremely small (0.1-60 seconds) residential time in a heating chamber in a highly reproducible and controllable manner, thereby synthesizing CdSe seeds with low size distribution and narrow emission bandwidth; c) synthesis of quantum rods using the prepared CdSe seeds. The independent precise control of reaction time and temperature including “flash” heat-up and cool-down of the reaction mixture entering and exiting the heating zone correspondingly, enables a boosted nucleation and homogeneous growth of the nanoparticles. Quantum rods with a very well reproducible PL properties including high photoluminescence quantum yield and narrow emission bandwidth can be obtained by the proposed method.

Solution delivery block includes:
one piston-type pump providing max. flow rate >150 ml/min at pressure >275 bar (e.g. HPLC Pump) with built-in pressure sensor,
two reservoirs with Solvent (TRPO) and Cd/Se precursors solution (in TRPO) equipped with inlet/outlet tubes for inert gas (N₂ or He) and stored under the blanket of an inert gas. The delivering solutions should be degassed, e.g. by immersing of both reservoirs into ultrasonic bath. Each of reservoirs is connected with Pump through the switching Valve 1 providing delivery of the liquid from only one of them.

Hot zone includes several sequential chambers (at least two) allowing to maintain different temperatures in each of them. Each chamber includes metal blocks with heaters and flow path, temperature sensors and temperature control unit. The range of available temperatures is from r.t. to 450° C. with accuracy not worth than ±1.0° C.

Cooler is a metal-made heat exchanger, where outlet tubing from the last hot zone immersed into jacket with circulated coolant (water or another appropriate cooling liquid). The temperature of coolant can be varied at least from +5° C. to room temperature.

Online detector is fluorescence flow detector. It can be composed of flow-cell, excitation light source and spectrometer.
Flow cell should be of pressure-resistant (up to 150 bar) type with short optical path cell (<1 mm) enabling detection of the fluorescence in high-concentrated solutions;
Excitation light source is a LED of at least 1 W power and emitting narrow band light (<10 nm FWHM) in the range of 360-420 nm;
Spectrometer, e.g. fibre-optical spectrometer is Ocean Optics USB 2000+ or similar one, enabling online recording the spectra every 0.5 s within the range at least 400-800 nm with resolution 1-2 nm and sensitivity not less than 30 photons/count.

Product collector consists of two reservoirs, Product and Waste, connected with two valves 2 and 3. Valve 2 allows redirecting the flow either to Product reservoir or to the inlet of Valve 3. Valve 3 allows redirecting the flow either to Waste or back to Solvent vessel for its recycling.

Optionally, the HPLC pump, temperature controllers, on-line detectors and all valves (in motorized design) can be connected to a PC and integrated in one computer controllable system.

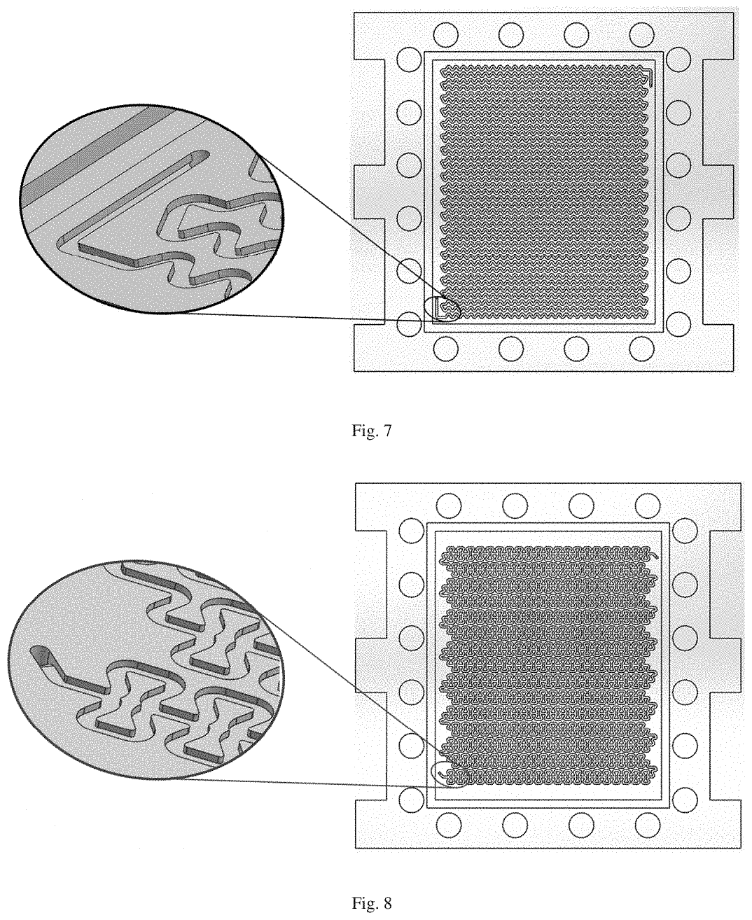

Here, for synthesis of CdSe seeds with the quality appropriate for the further preparation of QRs, we propose special design of heating chamber, which combines high thermal conductivity (fast homogeneous heating of the incoming flow), good mixing, and flow of liquid close to ideal plug flow regime (PFR). Several types of the heat chamber is proposed for the flow reactor to meet the needed requirements (FIGS. 4-9).

First type is filled column chambers, where the filler (metal spheres of micrometres size) serves both as vortex inducer of the flow and as heat transfer improvers. The column are either of round or flatted cross-section shape, the latter is preferable for better heat transfer from walls to inner volume of the flowing reactants. Similar to high performance liquid chromatography (HPLC) for similarly filled column, one can expect the PFR of the flow passing through the tube with minimized front and tail blurring. As an example of column type chamber, empty HPLC columns charged with 40-100 μm sized Ti spheres can be used (see FIG. 4).

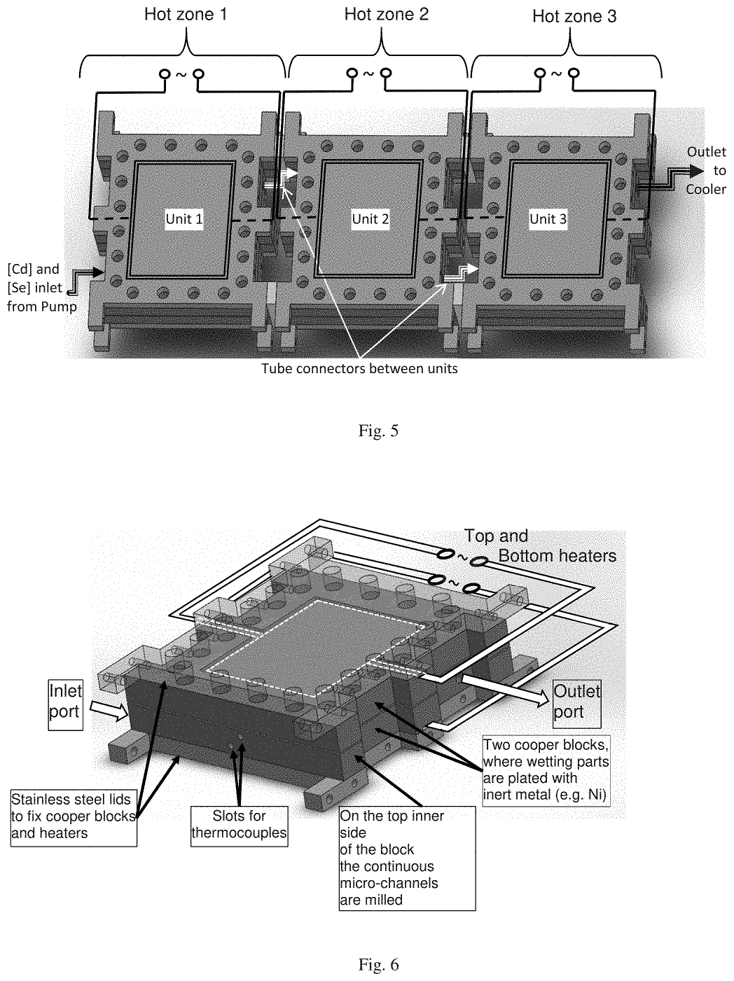

Other types of the heating chamber shown in FIGS. 5 and 6 are those where the inner channels have a specially designed shape (for example see Figures Error! Reference source not found. and Error! Reference source not found.). The design of such channel should provide a flow that is well mixing across the flow direction and avoiding stagnation zones. The channels are made on the top of one of the surface of a metal block, either by milling, etching, or assembled of several duly perforated plates, and then hermetically covered with a metal cap. Alternatively, channels are made by 3D metal printing technique. The 3D printing has several advantages; one of them concerns to avoiding issues with hermetical assembling of the chamber or prevention a cross-leakage, particular in the inner parts of the channels. The second advantage is essentially wider capability of channel design. As a potential drawback of the 3D metal printing technique is relatively higher roughness of the inner surface of the channels comparably to those made, e.g. by milling process. In the microchannel scale, especially in the case when flow is of divergent-convergent style (for example, see Error! Reference source not found.), the higher roughness potentially can result in non-equality of the flow through each sub-channel on the divergent section. Because of such non-equivalency, the local residential time, in these sub-channels, may vary, which in the worst case can result in blurring the margin of reaction zones, thereby increasing nanoparticles distribution and emission FWHM. The preferable but not limited design for 3D printed channels are coaxially displaced either plurality of microplates similarly as in Sulzer mixer, or micro-helicoidal inserts, sequentially providing an opposite twisting of the flow (Kenics mixer), see Background Error! Reference source not found.

The metal is chosen from, but not limited to, the chemically resistant metal, e.g. stainless steel, nickel, titanium, or made of high-heat conductive metal, e.g. cooper, further additionally plated in wetted path with thing protective layer of chemically resistant metal, e.g. nickel.

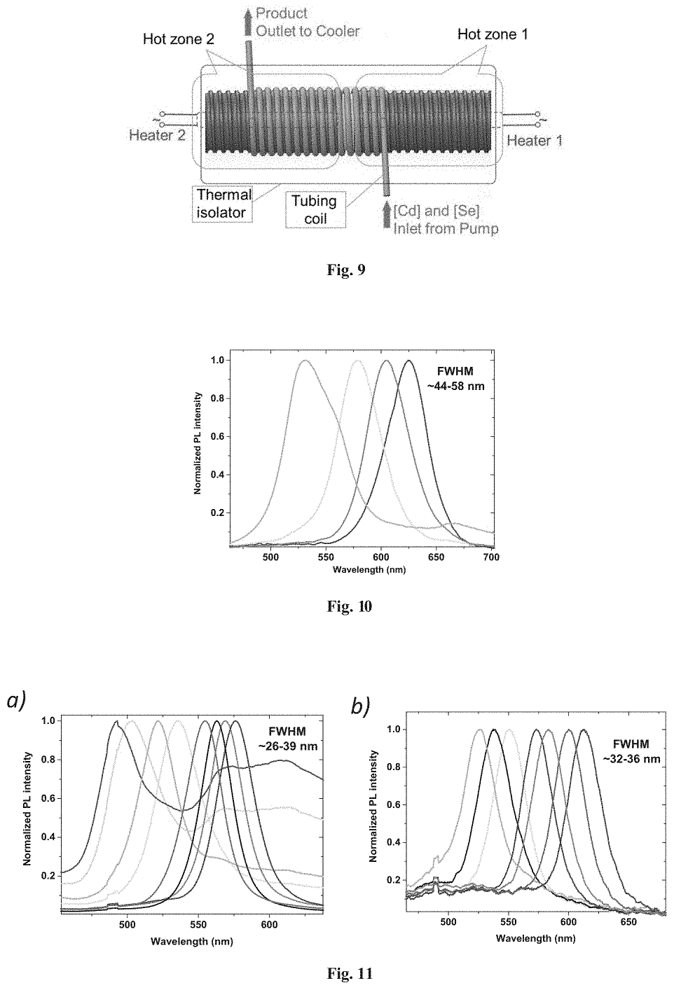

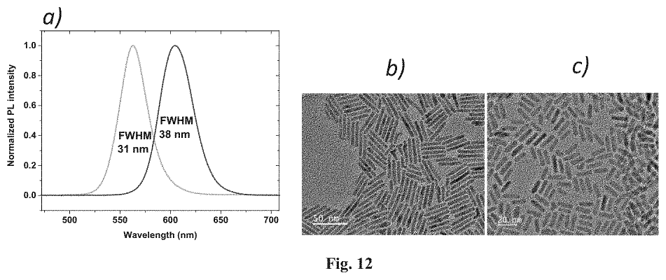

We also show that heating chamber of conventional tube type, used in common flow systems cannot be used for synthesis of CdSe of quality as high as in a batch reactor injection approach, and therefore, it is not applicable in the QRs synthesis process. For this, we tested tube with internal diameters 1 mm in the simplest coil type chamber (FIG. 9) and the results were worth, as it is seen from spectra shape and FWHM of the obtained NPs (see Error! Reference source not found. and Error! Reference source not found.), if compared to the proposed here highly efficient heat chamber (see Error! Reference source not found. and Error! Reference source not found.). Variation of the temperatures in hot zones also does not improve the results. Obviously, it is associated with increasing the size distribution of the QDs caused by various residential times at near-to-wall and central region of tube. A possible solution is application of micron sized capillary in the hot zone. However, the use of such microcapillaries results in significant decreasing the productivity (because of the lower flow rate) and increased probability of blocking.

TABLE 1
Synthesis of QDs seeds in coil type chamber

| Flow rate | λₘₐₓ | FWHM |
|---|---|---|
| (ml/min) | (nm) | (nm) |
| 4.5 | 625 | 44 |
| 6.5 | 605 | 45 |
| 8.5 | 579 | 47 |
| 10 | 531 | 58 (broadr) |

The results for two tested filled columns (ID=2.0 and 4.6 mm) are shown in Error! Reference source not found.. It is clearly seen that the PL quality of the obtained NPs is much better than that for both coil- and flat-type heating chambers. Thus, the emission peak position can be easily tuned in 500-620 nm spectral range, which is enough for synthesis of high quality green and red CdSe/CdS QRs. The latter were successfully synthesized from the as obtained CdSe QDs (see Error! Reference source not found.). FWHM for these CdSe QDs and CdSe/CdS QRs are in the range of 25-40 and 32-36 nm correspondingly, which matches with the best reported values for materials obtained in a batch reactor.

TABLE 2
Syntheis of QDs seeds in the chamber of column type filled
with Ti microspheres.

| Column size | Flow rate | T (1^{st} zone/2^{nd} zone/ | λₘₐₓ | FWHM |
|---|---|---|---|---|
| (ID/L, mm) | (ml/min) | 3^{rd} zone, ° C.) | (nm) | (nm) |
| 2.0/150 | 0.7 | 365/350/350 | 578 | 30 |
| 2.0/150 | 1 | 365/350/350 | 569 | 28 |
| 2.0/150 | 2 | 365/350/350 | 563 | 26 |
| 2.0/150 | 3 | 365/350/350 | 554 | 30 |
| 2.0/150 | 5 | 365/350/350 | 536 | 37 |
| 2.0/150 | 4.5 | 365/350/350 | 520 | 33 |
| 2.0/150 | 4 | 365/350/350 | 502 | 39 (br.) |
| 2.0/150 | 5 | 365/350/350 | 491 | br. |
| 4.6/75 | 1.5 | 400/320/320 | 612 | 34 |
| 4.6/75 | 2 | 400/320/320 | 600 | 32 |
| 4.6/75 | 2.5 | 400/320/320 | 583 | 34 |
| 4.6/75 | 3 | 400/320/320 | 573 | 32 |
| 4.6/75 | 3.5 | 400/320/320 | 550 | 32 |
| 4.6/75 | 4 | 400/320/320 | 539 | 36 |
| 4.6/75 | 4.5 | 400/320/320 | 526 | 36 |

### DETAILED EXAMPLES

### Example 1

### Preparation of Cd-Precursor

The mixture of CdO (3.52 g, 27.4 mmol), hexadecylphosphonic acid (15.06 g, 49.1 mmol) and TRPO (200 ml) were thoroughly degassed at reduced pressure at 130° C. for 90 min upon vigorous stirring: five cycles of pumping out and filling with inert gas (nitrogen) sequence were repeated. The mixture was then heated up to 330° C. during 1 hour and allowed to cool to r.t. This results in the obtained Cd concentration in solution 0.14 mm/g or 0.134 mol/L.

### Preparation of Se-Precursor

The vessel containing Se powder (5.0 g, 64.8 mmol) was degassed by means of nitrogen purging for 20 minutes at stirring. Then, trioctylphosphine (200 ml) was added and degassing was continued by bubbling of nitrogen through the suspension at stirring. The mixture was stirred for 1 hour until full dissolution of Se. The concentration of thus obtained Se solution is 25 g/L.

### Reaction Mixture for Flow Reactor

The as prepared Cd- and Se-precursors are mixed in a volume ratio 3/2 and the vessel is set into continuously working ultrasonic bath at temperature −45-55° C. under blanket of nitrogen.

### Synthesis of Cyan-Emitting CdSe QDs and the Corresponding Green-Emitting CdSe/CdS Quantum Rods

The experimental setup for flow synthesis of CdSe seeds is generally shown in Error! Reference source not found. The used heating chamber is of column type filled with 40-100 μm sized Ti sphere, see FIG. 4.

1 L of TRPO (as a Solvent) and 500 ml of mixed [Cd] and [Se] precursor solutions (reaction mixture) were transferred into the corresponding reagent delivery reservoirs equipped with gas-tight screw cap, two inlet/outlet inert gas (N₂) tubing, solvent delivery PTFE tubing capped with titanium 10 μm filter. Both solvent delivery tubes were attached to the switching Valve 1. Ultrasonic sonication of these chemicals (Solvent and Precursors) at temperature ˜45-55° C. under inert atmosphere (N₂ flow rate is ˜15 ml/min) was performed for 30 minutes for their degassing. Thereafter, N₂ flow was reduced to 4-5 ml/min and both these chemicals were kept under the flow of N₂ for all time of their use. The pump, detector/LED source and water chiller were switched on. The Valve 1 was set to suck the Solvent (individual TRPO). The Solvent was set for the recirculation regime: the Valve 2 is switched to Valve 3, and Valve 3 is switched to be connected with Solvent reservoir. The flow rate was set to 1 ml/min on the pump. All the temperature controllers were switched on and the in all hot zones to 120° C. was set. After that, the flow rate was set to 7.5 ml/min. The temperatures were set to 365/350/350° C. for the 1^{st}/2^{nd}/3^{rd} zones correspondingly. When the temperatures were stabilized the flow rate 5 m/min was set. When the temperature and pressure is stabilized (T deviation is less than 2° C. and pressure deviation is less than 50 psi), the Valve 3 was turned to connect with Waste discharge vessel and then the Valve 1 was set to position for supply of [Cd]/[Se] reaction mixture. When the PL spectra is stabilized by wavelength and intensity (˜20 s), the valve 2 was turned to collect the product. The collected solution of the product was mixed with equal amount of methanol and centrifuged at 7800 rpm for 5 min. The supernatant was discarded. The solid residue was then washed 2 times by means of dissolution in toluene, precipitation with methanol and separation on centrifuge. Finally, the product was dissolved in toluene and centrifuged to remove any insoluble material. Then, product was again precipitated from toluene solution with methanol and centrifuged. The obtained CdSe seeds precipitate was dissolved in appropriate amount of TOP to get the solution with concentration of CdSe seeds 20 g/L. In a separate flask, in 16 ml of this CdSe seeds solution the sulfur (840 mg, 26 mmol) was dissolved at with vigorous stirring and used at the next step.

CdO (900 mg, 7 mmol), hexadecylphoshonic acid (2.65 g, 8.6 mmol), hexylphosphonic acid (800 mg, 4.8 mmol) and trioctylphosphine oxide (30.0 g, 78 mmol) were thoroughly degassed at reduced pressure (10-20 mbar) at 130° C. for 90 min with vigorous stirring, followed by five cycles of pumping out and filling with inert gas (nitrogen) sequence. Then, the suspension was heated to 340° C. with vigorous stirring, after which it became transparent colorless solution. At this temperature, trioctylphosphine (10 ml) was swiftly injected. Then, the obtained above solution of CdSe seeds and S was swiftly injected to Cd-precursor solution at 375° C. The synthesis was terminated after 7 minutes by removing the heating source. When the temperature of the reaction mass decreased to 180° C., the 100 ml of toluene were added. After cooling to r.t., the product was precipitated with 50 ml of ethanol, collected by centrifugation, and washed once by re-dispersion in toluene (80 ml, 10 min of sonication) followed by precipitation with ethanol (40 ml, centrifugation). The obtained solid product was then re-dispersed in toluene (5 ml) and centrifuged at 4000 rpm for 10 min in order to remove insoluble materials. The solution was collected and filtered through a 0.2 μm PTFE filter. Then, solvent was evaporated under reduced pressure at 50° C. and dried in vacuo, the yield was 930 mg. PL spectra and TEM images of the obtained CdSe/CdS QRs are shown in Error! Reference source not found.

### Example 2

### Synthesis of Yellow-Emitting CdSe QDs and the Corresponding Red-Emitting CdSe/CdS Quantum Rods

Preparation of Cd-precursor and Se-precursor solutions as well as reaction mixture are essentially the same as described in Example 1. The synthesis of yellow-emitting CdSe QDs was performed using the same flow reactor and by the same procedure as described in Example 1 except of the flow rate, which was set to 0.7 ml/min. The CdSe seeds was isolated and purified similarly to Example 2, except that the Sulphur was dissolved in 12.8 ml of CdSe seeds solution in TOP (20 g/L). The further synthesis of the yellow-emitting CdSe/CdS quantum rods was performed in the same way, as in Example 2. Yield of CdSe/CdS quantum rods is 860 mg. PL spectra and TEM images of the obtained CdSe/CdS QRs are shown in Error! Reference source not found.

It should be understood that various forms of the processes shown above can be used, including reordering, adding or deleting step(s). For example, the steps described in the present disclosure can be executed in parallel, sequentially, or in a different order, as long as a desired result of the technical solution disclosed in the present disclosure can be achieved, and they are not restricted in the present disclosure.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only and is not intended to limit the invention so further described in such appended claims.

What is claimed is:

1. A method for synthesis of semiconductor luminescent nanorods CdSe/CdₓZn₍₁₋ₓ₎Se_{y}S_{(1-y)} comprising:
preparing single reaction mixture containing cadmium organophosphonate and Se-precursor, which is homogeneous liquid at room temperature;
pumping the said reaction mixture through the flow reactor heating zone to synthesize CdSe seeds of wurtzite crystal type with controllable emission wavelength, low size distribution, and narrow full width at half maximum of emission band;
synthesizing semiconductor luminescent nanorods from the said CdSe seeds.

2. The method of claim 1, wherein to homogeneously dissolve the Cd- and Se-precursors, the mixture of trialkylphosphineoxides of general formulae RR^{/}R^{//}PO is used as a solvent, where R, R^{/} and R^{//} are independently alkyl groups CₙH₂ₙ₊₁ with n being in the range of 1 to 30; or wherein R is a branched alkyl or alkenyl group or a branched carbon chain of total length in the range of 4 to 22 carbon atoms comprising one or more double bonds.

3. The method of claim 1, wherein the cadmium organophosphonate is alkyl- or alkenylphosphonates, where alkyl group is linear or branched CₙH₂ₙ₊₁ group with n being in the range of 3 to 30; or alkenyl group is linear or a branched carbon chain of total length in the range of 3 to 22 carbon atoms comprising one or more double bonds.

4. The method of claim 1, wherein the Se-precursor is obtained by dissolving the elemental Se in the trialkylphosphine of general formulae RR^{/}R^{//}P, where R, R^{/} and R^{//} are independently alkyl groups CₙH₂ₙ₊₁ with n being in the range of 1 to 30; or wherein R is a branched alkyl or alkenyl group or a branched carbon chain of total length in the range of 4 to 22 carbon atoms comprising one or more double bonds.

5. The method of claim 1, wherein the pumping of reaction mixture is performed by pulse-less high-pressure piston pump equipped with valves, with controllable flow rate.

6. The method of claim 5, wherein the pump provides the maximum flow rate no less than 10 ml/min at maximum backpressure no less than 10 bar and with accuracy of the flow rate no worth than 2%.

7. The method of claim 1, wherein emission wavelength of CdSe seeds is in the range of 480-620 nm and FWHM of emission band is less than 35 nm;

8. The method of claim 1, wherein the flow reactor comprises sequentially connected units with continuous flow channel, where at least one of the units is capable to heat the reaction mixture to 400° C. and at least one of the following unit is cooling unit.

9. The method of claim 8, wherein at least one of the flow reactor units in hot zone is a chamber with inlet and outlet ports, and tightly packed with inert filler.

10. The method of claim 9, wherein the inert filler is microparticles made of corrosive resistant metals or their alloy, or alumina, or silica, or silicon carbide, or graphite, or diamond.

11. The method of claim 10, wherein the inert filler is a non-porous material.

12. The method of claim 9, wherein the inert filler is made of good thermal conductive metal, plated with thin layer of chemically inert metal.

13. The method of claim 12, wherein the good thermal conductive metal is copper and chemically inert metal is nickel or its alloy.

14. The method of claim 8, wherein at least one of the flow reactor units in hot zone comprises metal block with continuous empty microchannel inside; the empty microchannel is connected with inlet and outlet ports.

15. The method of claim 8, wherein the metal block is made of corrosive resistant metals or their alloy.

16. The method of claim 15, wherein the corrosive resistant metals is chosen from one of the following: nickel, stainless steel, niobium, molybdenum, titanium or of their alloy.

17. The method of claim 14, wherein the metal block is made of good heat-transfer metal and the surface of the microchannel inside of the metal block is plated with thin layer of corrosive resistant metals or their alloy.

18. The method of claim 17, wherein the good heat-transfer metal is cooper and the corrosive resistant metal is nickel or its alloy.

19. The method of claim 14, wherein a continuous microchannel inside the metal block is made by 3D metal printing technique.

20. The method of claim 19, wherein microchannel includes coaxially displaced plurality of micro-plates or micro-helical inserts, which sequentially have left- or right-hand helicity thereby providing alternative radial twisting of the flow.

21. The method of claim 14, wherein a continuous empty microchannel inside the metal block is made on the top surface of one substrate and then hermetically covered with another substrate.

22. The method of claim 14, wherein a continuous empty microchannel has a zigzag periodical patterning.

23. The method of claim 14, wherein a continuous empty microchannel is a periodical plurality of divergent and convergent micro channels.

24. The method of claim 1, wherein the flow rate is controlled in the range from 0.1 to 1000 ml/min.

25. The method of claim 1, wherein the time of reaction mixture residence in the hot zone is controlled by the flow rate in the range from 0.1 to 60 s.

26. The method of claim 1, wherein semiconductor luminescent nanorods CdSe/CdₓZn₍₁₋ₓ₎Se_{y}S_{(1-y)} are synthesized in flow from the CdSe seeds of wurtzite crystal type without intermediate purification of the CdSe seeds.

27. The method of claim 1, wherein the as prepared CdSe seeds are purified from the reaction mixture prior the synthesis of semiconductor luminescent nanorods.

28. The method of claim 1, wherein the semiconductor luminescent nanorods are synthesized in a flow reactor.

29. The method of claim 1 wherein the semiconductor luminescent nanorods are synthesized in a batch reactor.

30. A flow reactor for synthesis of semiconductor CdSe seeds according to claim 8, wherein the cooling unit is provided for flash cooling (rapid cooling) of the reaction mixture. Cooling is used to stop the growth of CdSe seeds.

31. A reaction system for synthesizing semiconductor CdSe seeds according to claim 8, wherein flow reactor after cooling unit further includes with the detection system comprises a fluorescence detector, the fluorescence detector is used for in-situ monitoring and rapid feedback of the process to adjust the flow rate or temperature in the hot zone.
